(19) United States
(12) Patent Application Publication
(10) Pub. No.: US 2003/0137421 A1
(43) Pub. Date: Jul. 24, 2003

(54) Protective working device for miners

(76) Inventors: Peter Herkenrath, Bottrop (DE); Bernhard Richter, Hunstetten (DE)

Correspondence Address: Joel H. Bock, Cook, Alex, McFarron, Manzo,, Cummings & Mehler, Ltd., 200 West Adams Street - Suite 2850, Chicago, IL, 60606, US

(21) Appl. No.: 10/346,337

(22) Filed: Jan. 17, 2003

(30) Foreign Application Priority Data
Jan. 17, 2002 (DE) 10201505.8

(51) Int. Cl. G08B 23/00

(52) U.S. Cl. 340/573.1; 340/539.1; 340/825.49; 340/693.2

(57) ABSTRACT

The present invention relates to a protective working device (1) for miners, comprising a lamp (3) , which can for instance be attached to a protective helmet (2), and which is connected via a cable (4) to a supply battery (11) which can be fastened to an item of clothing such as a belt (6) and is supplied with electrical energy from the supply battery (11). A transponder device (13) is supplied with energy from the same battery (11) which interoperates with underground personnel detection systems such as detection sensors which monitor the working and operating areas of support frames for underground faces or of underground mining machines. In order to ensure the energy supply for the transponder device (13) over a significantly longer period than before and to provide the safety functions of the personnel detection system even under mining accidents, a safety circuit device (12) is provided, which switches off the energy supply to the lamp (3) if the remaining charge in the supply battery (11) falls below a predetermined remaining charge.

The present invention relates to a protective working device for miners, comprising a lamp which can preferably be attached or fastened to a protective helmet, and which is connected via a cable to a supply battery which can be fastened to an item of clothing such as a belt and is-supplied with electrical energy from the supply battery, and a transponder device fed from the same battery which interoperates with underground personnel detection systems such as detection sensors which monitor the working and operating areas of support frames for underground faces or of underground mining machines.

A working protection device in which both the lamp and also a transponder device are fed from the same energy source was proposed in U.S. Pat. No. 4,495,496. In this working protection device the cable connecting the supply battery to the lamp forms at the same time the receiving antenna for the interrogation signals transmitted from the personal detection system. The personal detection system comprises several data stations, which are separated from each other, which receive the transponder signals from the transponder at the same time and transfer these signals to a computer station in which the received data is evaluated. In this working protection device the transponder device and the lamp are coupled in such a technical manner that the transponder device is always in operation if the lamp is switched on. Using this device the presence or current position of personnel are detected in the underground mining faces who are carrying the transponder device. By the use of a, for example, bit-coded transponder signal the personnel can also be identified. The period of operation of the supply battery of this working protection device is designed to be some ten hours, whereby a four-volt battery is used.

The Assignee has proposed a personal recognition system for detection of the presence of people in underground mining operations, which concerns the preferred area of application of the current application. Specific reference is made here to DE 10029918 A1 and the content of this publication is included in the disclosure in the current application by naming it. In the known personnel detecting system in DE 10029918 A1 transponder devices have been applied up to the current time which have their own energy source or supply batteries. In order to detect personnel securely the transmitter unit of the personnel detecting system transmits an interrogation or detecting signal as a single dimension 9 kHz magnetic field. The transponder device is correspondingly designed for the lowest frequency range and works with a reception frequency of 9 kHz and a transmitting frequency of 2,455 MHz. The receiving unit of the transponder device is provided-with three antennas arranged in directions orthogonal to each other so as to ensure that a person equipped with a transponder device in the locating region of the transmitter of the personnel detection system will be detected.

Owing to the application of personnel detection systems and the equipment of all mining with a transponder device, the security of personnel in underground mining faces personnel can be noticeably increased. It is essential for the functioning of the personnel detection system that the energy supply for the transponder device is provided over the longest possible period. The energy supply of the transponder device must especially also be provided if mining personnel are buried by mining accidents. It can be essential for the life of buried miners to be found quickly and reliably by the mining rescue teams.

It is an aim of the present invention to ensure a significantly longer period of energy supply to the working protection.

Accordingly the present invention is directed to a protective working device for miners as described in the opening paragraph of the present specification in which it further comprises a security circuit device which automatically switches off the supply to the lamp if the remaining charge of the supply battery falls below a preset value. According to the present invention the advantage described in U.S. Pat. No. 4,495,496 of using the same supply battery both for the lamp and also the transponder device is retained, since the miner is careful as a result of experience to ensure that the supply battery for the lamp is fully charged before entering the workings. The present invention avoids the disadvantage of coupling the energy supply of the transponder device to the switching on of the lamp, since this shortens the energy supply for the transponder device in spite of its lower current drain. At the same time the solution according to the invention offers the advantage that the equipment to hand including the batteries available can continue to be used without more expensive and possibly heavier or bulkier supply batteries of higher capacity having to be procured. Since the energy consumption of the transponder device is substantially smaller in comparison to that of the lamp it is possible with suitable adjustment of the threshold value for remaining charge, to extend the energy supply for the transponder device and consequently the safety function of the personnel detection system by hours or days above the normal duration of operation.

In a preferred embodiment according to the invention the transponder device and the safety circuit device are integrated into one protective case together with the supply battery, especially in the connecting space of the supply battery for the lamp. It is understood that the whole circuit including the connecting cable to the lamp is designed to be intrinsically safe. Preferably the safety circuit comprises an electronic circuit. The arrangement of all the components in a protective case which can be carried on the rear side of the belt especially advantageously protects the individual components from destruction or contamination by dust and assures further that by the design using a single part the carrying of the personnel detection system is assured.

In order further to decrease the energy consumed by the transponder device, in a preferred embodiment it is permanently switched into a stand-by mode with low energy consumption and can be switched into an active condition with a higher consumption of energy on receipt of an activating signal transmitted by the personnel detection system, in which a transmitting module of the transponder device sends out a transponder signal automatically or based on an initiating signal such as is described in detail in DE 10029918 A1. The activating signal is advantageously an external magnetic field so that a three-dimensional receiving module of the transponder device can be addressed and activated independently of its orientation to the personnel detection system radiating or transmitting the magnetic field.

The area of application of the working protection device according to the invention and safety in underground faces can be increased further if the transponder device is provided with an additional circuit, which depending on the frequency of the received magnetic field transmits-different transponder signals via the transmitter module, whereby at least one transponder signal indicates the presence of a miner and another preferably coded transponder signal identifies the miner on the basis of an identification key in the personnel detection system. In accordance with the invention additional functions of the personnel detection system can be activated consequently upon the application of different frequencies of the external magnetic field forming the activation signal so as to be able to bring about additional aspects of safety engineering in addition to the detection of the presence of miners in determined face sections.

An example of a protective working device for miners according to the present invention will now be described hereinbelow with reference to the accompanying drawings, in which:

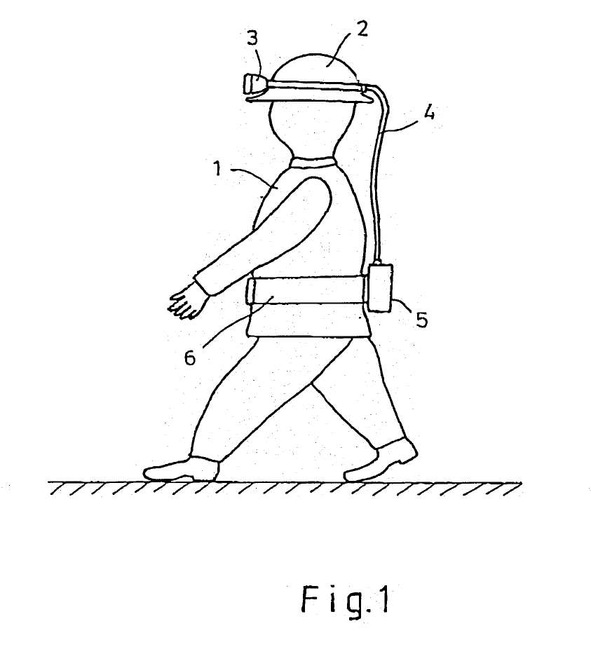

FIG. 1 shows a schematic drawing of a miner carrying a working protection device according to the present invention; and

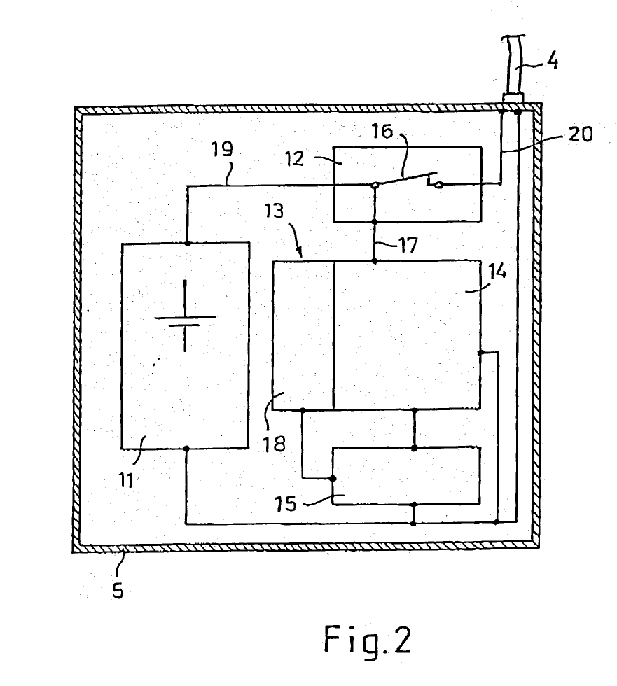

FIG. 2 shows a schematic diagram of the electrical and electronic components of the working protection device according to the present invention integrated into a protective case.

The miner 1 shown in FIG. 1 carries on his helmet 2 a lamp 3, which is connected via a cable 4 to a supply battery (11, FIG. 2), which is integrated with further electrical or electronic components in a protective case 5. The protective case 5 can be fastened to the belt 6 by means which are not shown, especially by loops, which the miner puts on before entering the workings on top of his working clothes.

As FIG. 2 shows, in the protective case 5 are integrated, as well as the supply battery 11, which for instance can have a supply voltage of 3 volt, a transponder device 13 shown schematically as a black box, as well as a safety circuit device 12. The transponder device 13 comprises a receiver module 14 and a transmitting module 15 whereby in the most simple embodiment the receiver module 14 comprises three passive 9 kHz receivers and the transmitting module for the transponder signal a 2,455 MHz transmitter which is switched in via a switching stage in the receiver module 14. The receiver module 14 and the transmitting module 15 preferably have a construction such as is described in DE 100 29 981 A1 reference to which is expressly made here.

Normally the automatically controlled electronic opening switch 16 of the security switching device 12 is closed and an electrical current flows from the supply battery 11 via the conductors 19, 20 and the cable 4 to the lamp (3, FIG. 1) and over the lines 19, 17 to the receiving module 14 of the transponder device 13. The safety circuit device 12 monitors the remaining charge of the supply battery 11 according to the invention and is designed such that if it falls below a preset threshold value for the remaining charge of the supply battery 11 the opening switch 16 automatically opens. The energy supply to the transponder device 13 via the lines 19, 17 is not controlled by this; the transponder device 13 forms however with the switch 16 opened, the only energy user.

In the embodiment shown the receiver module 14 of the transponder device 13 has a supplementary circuit 18 which depending on the frequency of the signal received by the receiving module controls the transmitter module 15 of the transponder device 13 such that the different transponder signals are transmitted. An uncoded transponder signal can hereby be representative of the condition that a miner is present. A coded transponder signal, which is transmitted exclusively on a different received frequency or radio frequency from that of the magnetic field or radio frequency transmitted by the personnel detection system, facilitates the identification of the miner via the identification key in the evaluation computer of the personnel detection system. The presence of the supplementary circuit device 18, the use of a transponder device 13, which is equipped for the reception of a single dimensional magnetic field with three orthogonally arranged antennas which is permanently switched into a standby mode with low energy consumption is activated only by the reception of an activating signal from the personnel detection system and only then switches on the transmitter module 15 forms the preferred embodiment.

The invention is not restricted to the working protection device shown schematically in the Figures and a number of modifications will be obvious to the specialist, which should fall within the area of protection of the attached claims. Thus for instance all the components and connections could be made onto a single circuit board in an electronic circuit.

1. A protective working device for miners, comprising a lamp which can preferably be attached or fastened to a protective helmet, and which is connected via a cable to a supply battery which can be fastened to an item of clothing such as a belt and is supplied with electrical energy from the supply battery, and a transponder device fed from the same battery which interoperates with underground personnel detection systems such as detection sensors which monitor the working and operating areas of support frames for underground faces or of underground mining machines, in which it further comprises a safety circuit device which automatically switches off the supply to the lamp if the remaining charge of the supply battery falls below a preset value.

2. A working protection device according to claim 1, in which the transponder device and the safety circuit device are integrated into one protective case together with the supply battery.

3. A working protection device according to claim 1, in which the safety circuit device comprises an electronic circuit.

4. A working protection device according to claim 1, in which the transponder device is switched permanently into a stand-by mode with low energy consumption and can be switched into an active condition with a higher energy consumption on receipt of an activating signal transmitted by the personnel detection system, in which the transmitting module of the transponder device transmits a transponder signal automatically or based on an initiating signal.

5. A working protection device according to claim 4, in which the activating signal is an external magnetic field and/or the transponder device has a three dimensional receiving module with antennas preferably arranged in orthogonal directions to each other.

6. A working protection device according to claim 1, in which the transponder device is provided with an additional circuit, which depending on the frequency of the received magnetic field transmits different transponder signals via the transmitter module (15), whereby at least one transponder signal indicates the presence of a miner and another transponder signal identifies the miner on the basis of an identification key in the personnel detection system.

7. A working protection device according to claim 1, in which the safety circuit device monitors the residual charge on the supply battery.
